(19) United States
(12) Patent Application Publication
(10) Pub. No.: US 2011/0018927 A1
(43) Pub. Date: Jan. 27, 2011

(54) METHOD FOR MANUFACTURING PLASMA DISPLAY PANEL

(76) Inventors: Tomohiro Murakoso, Hyogo (JP); Ryota Hamada, Hyogo (JP); Yasuhisa Ishikura, Osaka (JP); Eiichi Uriu, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/673,643

(22) PCT Filed: Jul. 30, 2009
(86) PCT No.: PCT/JP2009/003614

§ 371 Date: Feb. 16, 2010

(30) Foreign Application Priority Data
Aug. 1, 2008 (JP) 2008-199338

(51) Int. Cl. B41J 2/015

(52) U.S. Cl. 347/20

(57) ABSTRACT

The present invention provides a method for manufacturing a panel. According to the method, employing an ink containing particles of metal or particles of metal oxide allows transparent electrodes to be formed with high dimensional accuracy and little loss of productivity. Specifically, the transparent electrodes are formed in a manner that an ink containing particles of metal or particles of metal oxide is printed by inkjet printing as a plurality of ink dots with different diameters onto the front substrate.

### TECHNICAL FIELD

The present invention relates to a method for manufacturing an AC surface discharge-type plasma display panel used for a display device.

### BACKGROUND ART

An AC surface discharge-type plasma display panel, which has become dominance in plasma display panel (hereinafter simply referred to as a panel), has a front plate and a back plate oppositely disposed with each other and a plurality of discharge cells therebetween. The front plate has a glass front substrate, display electrode pairs each of which formed of a pair of a scan electrode and a sustain electrode, a dielectric layer and a protective layer that cover them. The back plate has a glass back substrate, data electrodes, a dielectric layer that covers the electrodes, barrier ribs, and phosphor layers. The front plate and the back plate are oppositely disposed and sealed with each other so that the display electrode pairs are located orthogonal to the data electrodes. The discharge space formed between the two plates is filled with discharge gas. The discharge cells are formed at which the display electrode pairs face the data electrodes. In the panel with the structure above, a gas discharge is generated in each discharge cell to excite phosphors of red, green, and blue. Color display is thus attained.

Each of the scan electrodes and the sustain electrodes is formed in a manner that, for example, a bus electrode of a narrow stripe is disposed on a transparent electrode of a wide stripe. To form the transparent electrode, for example, a thin film of indium tin oxide (ITO) formed on the front substrate by sputtering undergoes patterning by a photolithography method so as to be formed into a stripe shape. To form the bus electrode, paste of silver (Ag) is printed into a stripe shape on the transparent electrode and then fired (for example, see patent literature 1). However, to form an indium-tin-oxide (ITO) thin film by sputtering, it needs a vacuum device and an exposure device, that is, a large production facility is required. Besides, the forming process above has a problem of low productivity and high cost.

To address the problems above, some methods for forming a transparent electrode have been introduced. For example, an ink containing particles of metal chosen from indium (In), tin (Sn), antimony (Sb), aluminum (Al), and zinc (Zn) is applied and fired to form a transparent electrode (for example, see patent literature 2).

According to another method (see patent literature 3, for example), an ink is prepared in a manner that powder of indium-tin-oxide (ITO) superfine particles is dissolved into an organic solvent. The crystal grain boundary of the ITO superfine particles above is grown by firing a composite oxide of indium tin oxide (ITO) having indium (In) and tin (Sn) as an essential component at 350° C. to 800° C.

The distance between a scan electrode and a sustain electrode in a discharge cell, i.e., the distance of a discharge gap significantly affects discharge characteristics of the discharge cell. In the process of forming a discharge gap between transparent electrodes, large variations in distance of a discharge gap due to poor dimensional accuracy in printing a transparent electrode increase variations in discharge characteristics between discharge cells. This has brought unevenness to the display surface and impaired the quality of image display.

In terms of effective printing and application without wasted use of ink, inkjet printing excels as a method for forming a transparent electrode. However, in inkjet printing, the size of an ink dot affects dimensional accuracy; that is, forming the ink dot diameter as small as possible allows a transparent electrode to have further accurate dimension. On the other hand, however, an inkjet printing with a size-reduced ink dot increases the time for printing, decreasing productivity. Increasing the number of nozzles may contribute to increase in productivity; but the distance between adjacent nozzles cannot be decreased without limit. In actuality, from the constraints above, an inkjet printer has to have a plurality of print heads. This has brought a complex and expensive structure to an ink jet printer.

### CITATION LIST

### Patent Literature

### PATENT LITERATURE 1: Unexamined Japanese Patent Publication No. 2000-156168

### PATENT LITERATURE 2: Unexamined Japanese Patent Publication No. 2005-183054

### PATENT LITERATURE 3: Unexamined Japanese Patent Publication No. 2005-166350

### SUMMARY OF THE INVENTION

The present invention provides a method for manufacturing a plasma display panel having a plurality of pairs of transparent electrodes—each pair has a discharge gap therebetween—on the front substrate. According to the method, the transparent electrodes are formed in a manner that an ink containing particles of metal or particles of metal oxide is applied, by inkjet printing, to the front substrate as a plurality of ink dots with different diameters.

According to the inkjet printing method above, using an ink containing particles of metal or particles of metal oxide allows a transparent electrode to be formed with high dimensional accuracy and little loss of productivity.

### BRIEF DESCRIPTION OF THE DRAWINGS

FIG. 1 is an exploded perspective view showing the structure of the panel in accordance with an exemplary embodiment of the present invention.

FIG. 2A is a front view of the panel, seen from the front plate side, showing the detailed structure of the display electrode pairs.

FIG. 2B is a sectional view of the front plate showing the detailed structure of the display electrode pairs of the panel.

FIG. 3A is a view illustrating a method for manufacturing the front plate of the panel.

FIG. 3B is a view illustrating the method for manufacturing the front plate of the panel.

FIG. 3C is a view illustrating the method for manufacturing the front plate of the panel.

FIG. 3D is a view illustrating the method for manufacturing the front plate of the panel.

FIG. 3E is a view illustrating the method for manufacturing the front plate of the panel.

FIG. 4 shows a state where ink is printed onto the front substrate of the panel.

FIG. 5 is a detailed view of the wet layer of the panel.

FIG. 6A is a view illustrating the method for manufacturing the back plate of the panel.

FIG. 6B is a view illustrating the method for manufacturing the back plate of the panel.

FIG. 6C is a view illustrating the method for manufacturing the back plate of the panel.

FIG. 6D is a view illustrating the method for manufacturing the back plate of the panel.

FIG. 6E is a view illustrating the method for manufacturing the back plate of the panel.

### DETAILED DESCRIPTION OF THE PREFERRED EMBODIMENTS

An exemplary embodiment of the present invention is described hereinafter with reference to the accompanying drawings.

### An Exemplary Embodiment

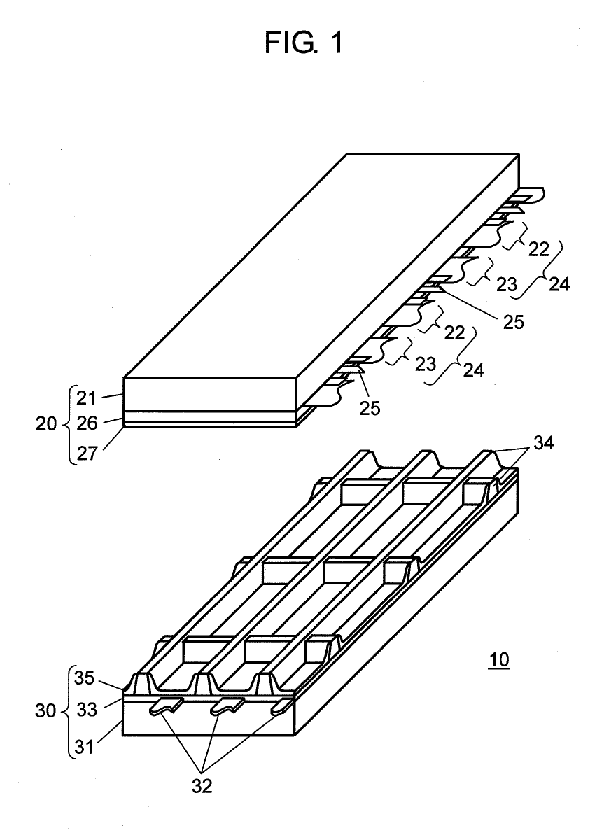

FIG. 1 is an exploded perspective view showing the structure of the panel in accordance with the first exemplary embodiment of the present invention. Panel 10 has a structure where oppositely disposed front plate 20 and back plate 30 are sealed at the peripheries with sealing material (not shown) and a plurality of discharge cells are formed inside.

Front plate 20 has glass-made front substrate 21, display electrode pairs 24 formed of scan electrodes 22 and sustain electrodes 23, black stripes 25, dielectric layer 26, and protective layer 27. On front substrate 21, display electrode pairs 24, each of which is a pair of scan electrode 22 and sustain electrode 23, are formed in parallel with each other. Besides, black stripe 25 is formed between adjacent display electrode pairs 24.

Although FIG. 1 shows an arrangement of display electrode pairs 24 and black stripe 25, where scan electrode 22, sustain electrode 23, black stripe 25, scan electrode 22, sustain electrode 23, black stripe 25 are repeatedly disposed in the order named, it is not limited to; display electrode pairs 24 and black stripe 25 may be arranged in the following order: scan electrode 22, sustain electrode 23, black stripe 25, sustain electrode 23, scan electrode 22, black stripe 25, scan electrode 22, sustain electrode 23, black stripe 25, sustain electrode 23, scan electrode 22, black stripe 25, and so on.

Dielectric layer 26 is formed so as to cover display electrode pairs 24 and black stripes 25, and protective layer 27 is formed over dielectric layer 26.

Back plate 30 has glass-made back substrate 31, data electrodes 32, base dielectric layer 33, barrier ribs 34, and phosphor layers 35. A plurality of data electrodes 32 are formed in parallel with each other on back substrate 31. Base dielectric layer 33 is formed so as to cover data electrodes 32, and grid-like barrier ribs 34 are formed on base dielectric layer 33. In addition, phosphor layers 35 of red, green, and blue are formed on the surface of base dielectric layer 33 and on the side surface of barrier ribs 34.

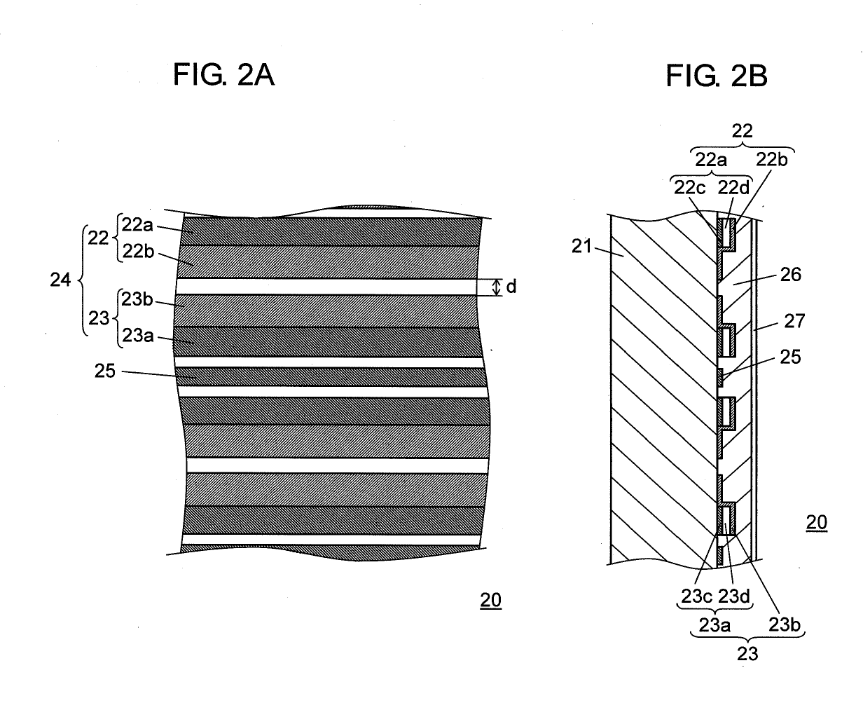

FIG. 2A is a front view of the panel, seen from the front plate side, which shows the detailed structure of the display electrode pairs in accordance with the first exemplary embodiment of the present invention. FIG. 2B is a sectional view of the front plate and shows the detailed structure of the display electrode pairs of the panel in accordance with the first exemplary embodiment of the present invention.

Scan electrode 22 has opaque first bus electrode 22a and transparent first transparent electrode 22b. Similarly, sustain electrode 23 has second bus electrode 23a and second transparent electrode 23b. A discharge gap having distance d is formed between a pair of the transparent electrodes, i.e., between first transparent electrode 22b and second transparent electrode 23b. Hereinafter, first bus electrode 22a and second bus electrode 22a are simply referred to as bus electrode 22a and bus electrode 23a, respectively; first transparent electrode 22b and second transparent electrode 23b are referred to as transparent electrode 22b and transparent electrode 23b, respectively.

Bus electrode 22a is formed of black layer 22c and conductive layer 22d, and bus electrode 23a is formed of black layer 23c and conductive layer 23d. Black layers 22c, 23c are disposed for making bus electrodes 22a, 23a look black, respectively, when panel 10 is seen from the display surface side. The black layers are formed of a black material, for example, having ruthenium oxide (RuO₂) as the main component and are formed into a narrow stripe shape on front substrate 21. Conductive layers 22d, 23d have a layered structure of conductive material including silver (Ag) and formed on black layers 22c, 23c, respectively. Conductive layers 22d, 23d enhance conductivity of bus electrodes 22a, 23a.

Black stripes 25 are disposed for making the display surface look black when panel 10 is seen from the display surface side. Black stripes 25 are formed of, for example, a black material containing ruthenium oxide (RuO₂) as the main component and are disposed on front substrate 21.

Transparent electrodes 22b and 23b are disposed not only for generating a strong electric field and accordingly generating a discharge in the discharge space, but also for drawing light generated from phosphor layers 35 outside panel 10. Transparent electrode 22b is formed in a manner that an ink containing particles of metal or particles of metal oxide is printed into a wide stripe shape so as to cover at least a part of bus electrode 22a and is fired in an oxidizing atmosphere.

Similarly, transparent electrode 23b is formed in a manner that an ink containing particles of metal or particles of metal oxide is printed into a wide stripe shape so as to cover at least a part of bus electrode 23a and is fired in an oxidizing atmosphere.

In the description of the embodiment, each of bus electrodes 22a and 23a has a width of 80 μm, and each of transparent electrodes 22b and 23b has a width of 160 μm. Besides, each of overlaps between bus electrode 22a and transparent electrode 22b, and between bus electrode 23a and transparent electrode 23b is determined to 80 μm. A discharge gap has a width of 60 μm. The values above should preferably be determined according to specifications of panel 10 and the like.

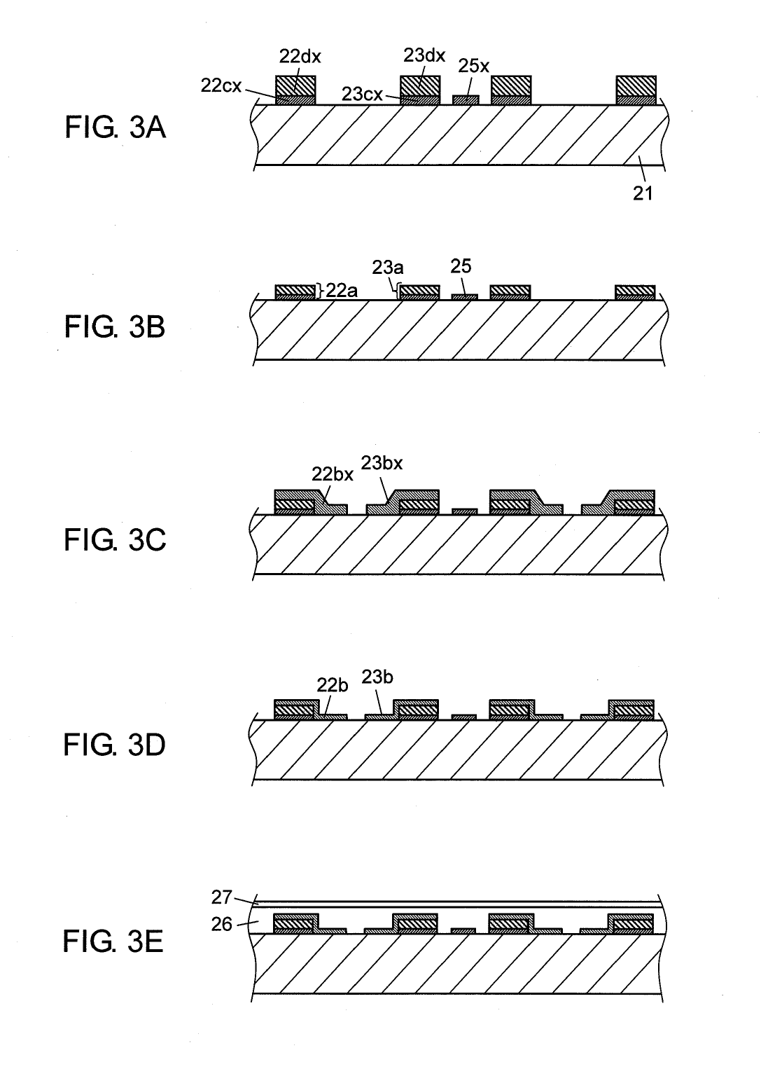

Next, the manufacturing method of panel 10 will be described. FIGS. 3A, 3B, 3C, 3D, and 3E are the views for illustrating the method for manufacturing the front plate of the panel in accordance with the first exemplary embodiment of the present invention.

As the first step of manufacturing front plate 20, glass-made front substrate 21 undergoes alkali cleaning. After that, as shown in FIG. 3A, precursors 22cx, 23cx for black layers 22c, 23c and precursor 25x for black stripe 25 are formed on front substrate 21. The precursors above are made of black layer paste containing ruthenium oxide (RuO₂) and black pigment as the main component. Precursors 22cx, 23cx, and 25x are formed by heretofore known technique, such as screen printing and photolithography. After that, precursors 22dx, 23dx for conductive layers 22d, 23d are formed on precursors 22cx, 23cx. The precursors for the conductive layers are made of conductive layer paste containing silver (Ag).

The “precursor” termed in the present invention is the applied paste for structure member, such as black layer paste, that undergoes a thermal process until reaching a state where an organic component originally contained in the paste has been removed and an inorganic component does not melt.

Next, as shown in FIG. 3B, bus electrodes 22a, 23a and black stripe 25 are formed by firing front substrate 21 on which precursors 22cx, 23cx, 25x, 22dx, and 23dx have been formed. The peak temperature in the firing process should preferably be 550° C. to 600° C. In the embodiment, it is set at 580° C. The thickness of bus electrodes 22a, 23a should preferably be 1 to 6 μm. In the embodiment, it is determined at 4 μm.

Next, as shown in FIG. 3C, transparent electrodes 22b and 23b are formed. First, an ink containing any one of the following particles with an average particle diameter of 5 nm to 100 nm is prepared:
particles of metal formed of at least one of indium (In), tin (Sn), antimony (Sb), aluminum (Al), and zinc (Zn);
particles of metal oxide formed of at least one of the metals above (where, the particles may be composite oxide particles that contain two or more elements of the metals above);
particles of alloy formed of two or more metals above; and
a mixture of the particles above.

In the embodiment, the ink is formed in a manner that particles of indium (In)-tin (Sn) alloy with an average particle diameter of 10 nm are dispersed at a concentration of 12 wt % into an organic solvent with dispersant. In the embodiment, decahydronaphthalene is used for the organic solvent. Instead, for example, the followings can be employed: nonpolar solvent, such as toluene, xylene, benzene, tetradecane; aromatic hydrocarbon group; long-chain alkane, such as hexane, heptane, octane, nonane, decane, undecane, dodecane, tridecane, tetradecane, pentadecane, hexadecane, octadecane, nonadecane, eicosane, trimethylpentane; and cyclic alkane, such as cyclohexaane, cycloheptane, cyclooctane.

Next, wet layer 22bx is formed in a manner that the ink is printed, by an inkjet printer, into a wide stripe shape so as to cover at least a part of bus electrode 22a. Similarly, wet layer 23bx is formed in a manner that the ink is printed into a wide stripe shape so as to cover at least a part of bus electrode 23a.

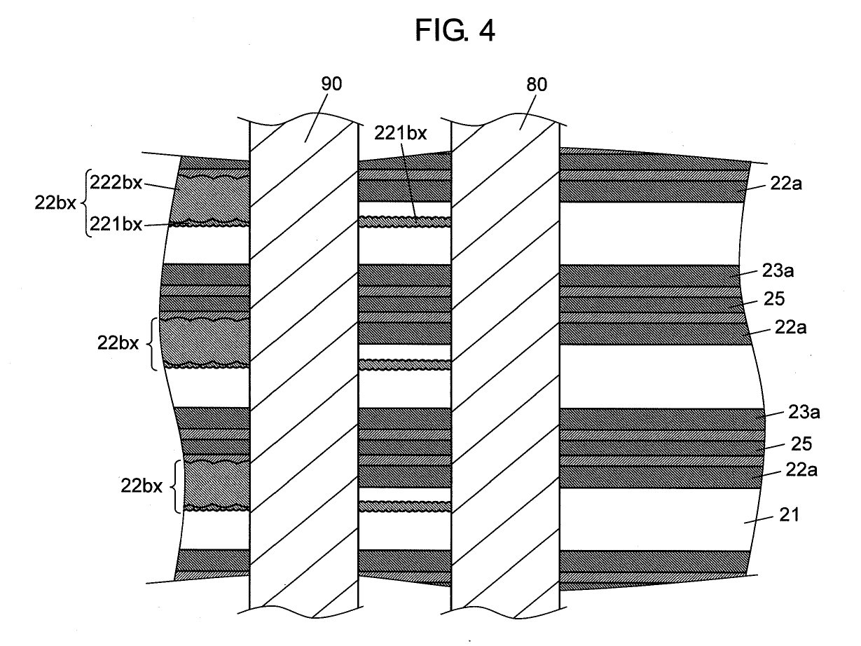

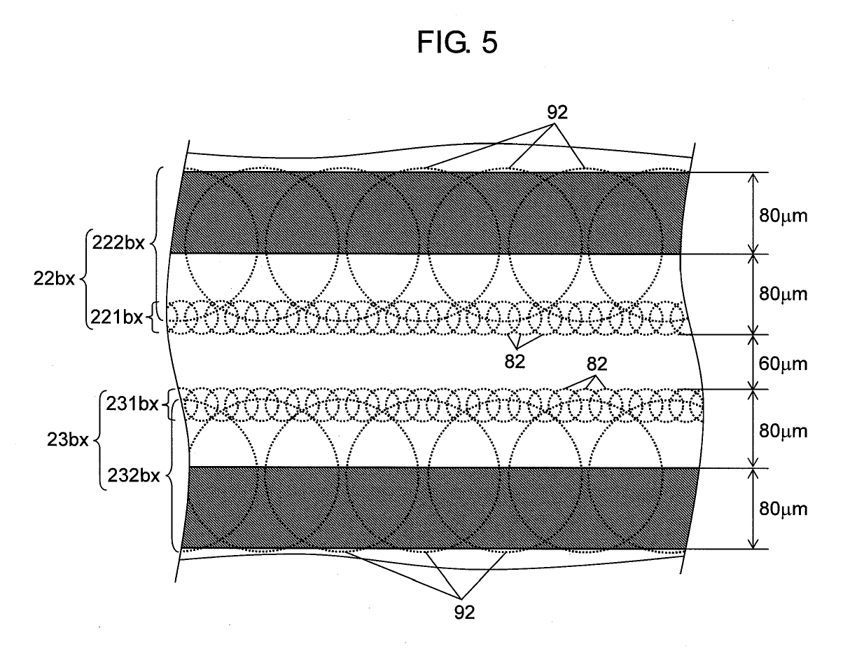

FIG. 4 shows a state where the ink is printed onto front substrate 21 of panel 10. FIG. 5 is an enlarged view showing the details of wet layers 22bx and 23bx.

The inkjet printer, as shown in FIG. 4, has print head 80 with a print nozzle of a small diameter and print head 90 with a print nozzle of a large diameter. Each of print heads 80 and 90 has a plurality of print nozzles with a pitch determined at an integral multiple of the repeat pitch of display electrode pairs 24.

According to the embodiment, print head 80 has 768 print nozzles for each repeat pitch of display electrode pairs 24, and each nozzle has a diameter of 20 μm. The print nozzle is so designed that the nozzle jets out ink droplet with a diameter of about 25 μm to form ink dot 82 with a diameter of about 30 μm when the droplet lands on front substrate 21. Print head 80 applies ink in such a way that ink dots 82 are formed in a row with an overlap one another. In this way, wet layer 221bx with a narrow width is formed on the discharge-gap side of first transparent electrode 22b, and similarly, wet layer 231bx with a narrow width is formed on the discharge-gap side of second transparent electrode 23b.

On the other hand, print head 90 has 768 print nozzles for each repeat pitch of display electrode pairs 24, and each nozzle has a diameter of 120 μm. The print nozzle is so designed that the nozzle jets out ink droplet with a diameter of about 140 μm to form ink dot 92 with a diameter of about 160 μm when the droplet lands on front substrate 21. Print head 90 applies ink in such a way that ink dots 92 is not only formed in a row with an overlap one another but also formed so as to overlap with a part of wet layer 221bx on the discharge-gap side and at least a part of bus electrode 22a, so that wet layer 222bx is formed into a wide width. Similarly, print head 90 applies ink in such a way that ink dots 92 is not only formed in a row with an overlap one another but also formed so as to overlap with a part of wet layer 231bx on the discharge-gap side and at least a part of bus electrode 23a, so that wet layer 232bx is formed into a wide width.

In the embodiment, first, the nozzles of print head 80 and print head 90 are positioned at first transparent electrodes 22b to print 768 wet layers 221bx and 768 wet layers 222bx, by which 768 wet layers 22bx are formed. Next, the nozzles of print head 80 and print head 90 are positioned at second transparent electrodes 23b to print 768 wet layers 231bx and 768 wet layers 232bx, by which 768 wet layers 23bx are formed. In this way, 768 wet layers 231bx and 768 wet layers 232bx are completed by two-time printing per one-round movement of the print heads.

After that, as shown in FIG. 3D, front substrate 21 having wet layers 22bx and 23bx is dried and fired at temperatures ranging from 400° C. to 600° C. in an oxidizing atmosphere. Through the process, transparent electrodes 22b and 23b, which are made of a transparent conductive film with a thickness of 80 nm to 1000 nm, are formed. In the embodiment, front substrate 21 having wet layers 22bx and 23bx formed thereon is dried while maintained for 10 min. at a temperature of 230° C. under reduced pressure of 1×10⁻³ Pa. After that, it is fired for 60 min. at a temperature of 500° C. in the air, so that transparent electrodes 22b and 23b, which are made of indium-tin oxide (ITO) film with a thickness of approx. 300 nm, are formed.

Next, as shown in FIG. 3E, the precursor for dielectric layer 26 is formed, by printing or other heretofore known technique, on front substrate 21 on which scan electrodes 22, sustain electrodes 23, and black stripes 25 have been formed. The precursor for dielectric layer 26 is fired so as to form dielectric layer 26 with a thickness of 20 to 50 μm.

The dielectric paste formed in the embodiment contains dielectric glass having the following composition: 34.6 wt % boron oxide (B₂O₃), 1.4 wt % silicon oxide (SiO₂), 27.6 wt % zinc oxide (ZnO), 3.3 wt % barium oxide (BaO), 25 wt % bismuth oxide (Bi₂O₃), 1.1 wt % aluminum oxide (Al₂O₃), 4.0 wt % molybdenum oxide (MoO₃), and 3.0 wt % tungsten oxide (WO₃). The softening point of the dielectric glass is about 570° C. Next, the precursor (not shown) for dielectric layer 26 is formed by applying dielectric paste, by die coating, onto front substrate 21 having scan electrodes 22, sustain electrodes 23, and black stripes 25 thereon. The precursor (not shown) for dielectric layer 26 is then fired at about 590° C., so that dielectric layer 26 with a thickness of about 40 μm is formed.

Instead of the dielectric paste above, for example, a dielectric paste containing dielectric glass that has a softening point of 520° C. to 590° C. and contains some of the followings can be used: boron oxide (B₂O₃), silicon oxide (SiO₂), zinc oxide (ZnO), bismuth oxide (Bi₂O₃), aluminum oxide (Al₂O₃), molybdenum oxide (MoO₃), tungsten oxide (WO₃), cerium oxide (CeO), alkaline-earth metal oxide, and alkali metal oxide.

Protective layer 27 having magnesium oxide (MgO) as the main component is formed on dielectric layer 26 by a vacuum deposition method or other heretofore known technique.

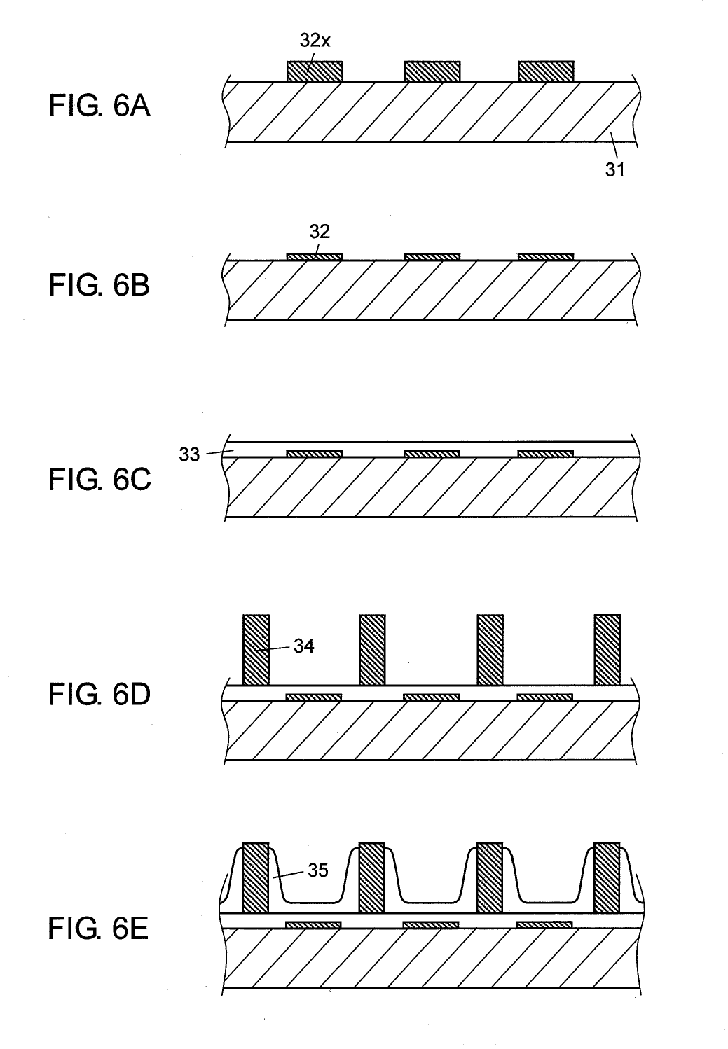

Next, the method for manufacturing back plate 30 will be described. FIGS. 6A, 6B, 6C, 6D, and 6E illustrate the method for manufacturing the back plate of the panel in accordance with the exemplary embodiment of the present invention.

First, as shown in FIG. 6A, conductive layer paste having silver (Ag) as the main component is applied onto back substrate 31 so as to have an evenly spaced stripe shape by heretofore known technique, for example, screen printing and photolithography. Precursors 32x for data electrodes 32 are thus formed.

Next, as shown in FIG. 6B, data electrodes 32 are formed by firing back substrate 31 having precursors 32x thereon. Data electrode 32 has a thickness of, for example, 2 μm to 10 μm.

Next, as shown in FIG. 6C, dielectric paste is applied onto back substrate 31 having data electrodes 32 thereon and then fired so as to form base dielectric layer 33. Base dielectric layer 33 has a thickness of, for example, approx. 5 μm to 15 μm.

Next, as shown in FIG. 6D, after photosensitive dielectric paste is applied onto back substrate 31 having base dielectric layer 33 thereon, the paste is dried so as to form the precursor for barrier ribs 34. After that, barrier ribs 34 are formed by photolithography or other heretofore known technique. Barrier ribs 34 have a height of, for example, 100 μm to 150 μm.

Next, as shown in FIG. 6E, phosphor ink containing any one of red, green, and blue phosphors is applied to the wall surface of barrier ribs 34 and the surface of dielectric layer 33. After that, the ink is dried and then fired so as to form phosphor layers 35.

A red phosphor may be formed of, for example, (Y, Gd) BO₃:Eu, (Y, V) PO₄:Eu. A green phosphor may be formed of, for example, Zn₂SiO₄:Mn, (Y, Gd) BO₃:Tb, (Y, Gd) Al₃(BO₃)₄:Tb. A blue phosphor may be formed of, for example, BaMgAl₁₀O₁₇:Eu, Sr₃MgSi₂O₈:Eu.

Front plate 20 and back plate 30 are oppositely disposed so that display electrode pairs 24 are positioned orthogonal to data electrodes 32. The two plates are sealed with low-melting glass at the peripheries outside the image display area where the discharge cells are formed. After that, the discharge space inside the plates is filled with discharge gas containing xenon. Panel 10 is thus completed.

According to the embodiment, as described above, transparent electrodes 22b and 23b are formed by inkjet printing in a manner that an ink containing particles of metal or particles of metal oxide is applied to front substrate 21 so as to form ink dots 82 and 92 that differ in diameter.

Besides, in the forming process of transparent electrodes 22b and 23b, ink dot 82 on the discharge-gap side of transparent electrodes 22b and 23b has a diameter smaller than that of ink dot 92 applied to the opposite side of the discharge gap.

Further, transparent electrodes 22b and 23b are formed by ink dots 82 and 92, which differ in diameter, printed in two rows.

According to the embodiment, the inkjet printer for forming wet layers 22bx and 23bx has print head 80 and print head 90. Print head 80 has print nozzles with a small diameter and print head 90 has print nozzles with a large diameter. The print nozzles with a small diameter of print head 80 apply ink in a manner that ink dots 82 form one row with an overlap provided therebetween. Through the printing above, narrow-width wet layer 221bx on the discharge-gap side of first transparent electrode 22b and narrow-width wet layer 231bx on the discharge-gap side of second transparent electrode 23b are formed. That is, a discharge gap is formed between wet layers 221bx and 231bx, i.e., formed between two rows of small ink dots 82.

In the process above, variation in such formed discharge gap is nearly equivalent to one-tenth of the diameter of small ink dot 82. In the embodiment, small ink dot 82 has a diameter of 30 μm, i.e., the variation in discharge gap remains at approx. 3 μm. This achieves dimensional accuracy as high as that acquired by photolithography. That is, the manufacturing process of the embodiment with use of an inkjet printer allows panel 10 to have discharge gaps with small variations. As a guide of setting, the diameter of small ink dot 82 should be at most ten times the dimensional accuracy required to the discharge gap, and at the same time, it should be at least one-tenth the diameter of large ink dot 92.

According to the embodiment, print head 90 having a print nozzle of a large diameter applies ink in such a way that ink dots 92 is not only formed in a row with an overlap one another but also formed so as to overlap with a part of wet layer 221bx on the discharge-gap side and at least a part of bus electrode 22a, so that wet layer 222bx is formed into a wide width. Print head 90 also applies ink in such a way that ink dots 92 is not only formed in a row with an overlap one another but also formed so as to overlap with a part of wet layer 231bx on the discharge-gap side and at least a part of bus electrode 23a, so that wet layer 232bx is formed into a wide width.

As described above, ink dots 92 are printed, by print head 90 having a print nozzle of a large diameter, so as to have a diameter of 160 μm that nearly equals the width of transparent electrodes 22b, 23b. That is, each of wet layers 222bx and 232bx of wide widths can be formed by ink dots 92 printed in one row.

Suppose that transparent electrodes 22b and 23b are formed by print head 80 alone that has a print nozzle of a small diameter of 30 μm. In that case, an ink dot of 30 μm has to be repeatedly printed with an overlap. To form transparent electrode 22b (23b) of a width of 160 μm, ink dots 82 of approx. 10 rows are required. That is, 20 printing processes of ten-round movements are necessary for forming wet layers 22bx and 23bx, seriously impairing productivity. On paper, the productivity the same level as that of the embodiment can be maintained by 10 sets of print heads 80; however, an elaborate inkjet printer with a complicated structure is required. Besides, employing a plurality of high-priced print heads raises the price of the inkjet printer.

According to the embodiment, however, wide-width transparent electrodes 22b and 23b are formed of one-row ink dots 92 printed by print head 90 with a print nozzle of a large diameter. This allows the productivity to be maintained at a high level. The diameter of large ink dot 92 should be determined to be equivalent to, or slightly smaller than the width required for transparent electrodes 22b and 23b.

As described above, in the embodiment, employing the row of small-diameter ink dots 82—printed by print head 80 of a small-diameter print nozzle—allows the discharge gap to be formed with high dimensional accuracy. Further, employing the row of large-diameter ink dots 92—printed by print head 90 of a large-diameter print nozzle—allows transparent electrodes 22b and 23b to be formed with high productivity.

According to the embodiment, an ink containing particles of metal is printed into stripes by inkjet printing. The inkjet printing described above allows the patterning process to be completed with high dimensional accuracy and the least wasted ink.

Besides, in the embodiment, transparent electrode 22b is formed in a manner that an ink containing particles of metal, such as indium (In) and tin (Sn), is printed into a wide stripe shape so as to cover at least a part of bus electrode 22a and is fired in an oxidizing atmosphere.

Similarly, transparent electrode 23b is formed in a manner that an ink containing particles of metal, such as indium (In) and tin (Sn), is printed into a wide stripe shape so as to cover at least a part of bus electrode 23a and is fired in an oxidizing atmosphere.

In the next process that follows above, dielectric layer 26 is formed so as to cover transparent electrodes 22b and 23b. The structure considerably reduces the risk of damage and peel-off of transparent electrodes 22b and 23b even when they have insufficient mechanical strength.

According to the embodiment, transparent electrodes 22b and 23b are formed in a manner that an ink containing indium (In)-tin (Sn) alloy particles with an average diameter of 10 nm is printed and then fired at a high temperature of 500° C. Such formed transparent electrodes not only have low resistance, high transmittance, but also keep an intimate contact with front substrate 21 and bus electrodes 22a, 23a. This is considered that the firing process at high temperatures allows the particles to be expanded during the change from indium (In) to indium oxide (In₂O₃), enhancing the contact between the particles and between the particles and the substrate.

Besides, according to the embodiment, transparent electrodes 22b and 23b are formed of metal particles with an average particle diameter of 5 to 100 nm. Particles with an average particle diameter smaller than 5 nm easily causes reaction of the particles to the dielectric glass, and at the same time, easily causes a crack at the stepped section between the transparent electrodes and silver (Ag)-contained bus electrodes 22a, 23a. On the other hand, particles with an average particle diameter greater than 100 nm easily cause clogging in the minute nozzle of the inkjet printer. Besides, if the average particle diameter becomes excessively large, the contact area between the particles after the firing process decreases, resulting in increased sheet resistance.

Although the inkjet printer used in the embodiment has print head 80 with a print nozzle of a small diameter and print head 90 with a print nozzle of a large diameter, the present invention is not limited to the structure above. For example, two types of inkjet printer—one has a print head with a print nozzle of a small diameter and the other has a print head with a print nozzle of a large diameter—may be employed. With the structure above, wet layers 221bx and 231bx are formed by one inkjet printer with a print nozzle of a small diameter, whereas wet layers 222bx and 232bx are formed by the other inkjet printer with a print nozzle of a large diameter. Besides, productivity may be further enhanced by employing an inkjet printer having a structure where the number of print nozzles of a small diameter is greater than that of print nozzles of a large diameter.

In the embodiment, transparent electrodes 22b and 23b are formed of indium tin oxide (ITO) with the use of particles of indium (In)-tin (Sn) alloy, but it is not limited thereto. For example, the transparent electrodes may be formed of a tin oxide (SnO₂) film with the use of particles of tin (Sn). As still another possibility, the transparent electrodes may be formed of a zinc oxide (ZnO) film with the use of particles of zinc (Zn).

In the embodiment, after precursors 22cx, 23cx, 22dx, and 23dx are fired, wet layers 22bx and 23bx are formed and fired, but it is not limited thereto. For example, scan electrodes 22 and sustain electrodes 23 may be formed in a manner that, after precursors 22cx, 23cx, 22dx, and 23dx are formed and then further wet layers 22bx and 23bx are formed on the precursors, the precursors 22cx, 23cx, 22dx, 23dx, wet layers 22bx, 23bx are fired at the same time.

Although wet layers 22bx and 23bx of the embodiment are formed by printing the two-row ink dots formed of one row of small-diameter ink dots 82 and one row of large-diameter ink dots 92, the present invention is not limited to the structure above. Any one of wet layers 22bx and 23bx, or both of them may be formed by printing three or more rows of ink dots with different diameters. In that case, too, the diameter of an ink dot to be applied on the discharge-gap side should preferably be smaller than those of other ink dots. Between ink dots and between an ink dot and the bus electrode should be maintained at a distance that has an electrical continuity where the ink dots have no electrical floating condition.

Specific values seen in the description of the embodiment are cited merely by way of example. They should be optimally determined according to, for example, specifications of a panel.

### INDUSTRIAL APPLICABILITY

According to the present invention, a transparent electrode is formed by printing an ink containing particles of metal or particles of metal oxide by inkjet printing. The manufacturing method above allows the transparent electrodes to have high dimensional accuracy and little loss of productivity. It is therefore useful for manufacturing a panel having transparent electrodes.

### REFERENCE MARKS IN THE DRAWINGS

10 panel
20 front plate
21 front substrate
22 scan electrode
22a (first) bus electrode
22b (first) transparent electrode
22bx, 23bx wet layer
22c, 23c black layer
23 sustain electrode
22cx, 23cx precursor (for black layer)
22d, 23d conductive layer
22dx, 23dx precursor (for conductive layer)
23a (second) bus electrode
23b (second) transparent electrode
24 display electrode pair
25 black stripe
25x precursor (for black stripe)
26 dielectric layer
27 protective layer
30 back plate
31 back substrate
32 data electrode
32x precursor (for data electrode)
33 base dielectric layer
34 barrier rib
35 phosphor layer
80 print head (with print nozzle of small diameter)
90 print head (with print nozzle of large diameter)
82 (small) ink dot
92 (large) ink dot
221bx, 231bx (narrow-width) wet layer
222bx, 232bx (wide-width) wet layer

1. A method for manufacturing a plasma display panel having a structure where a plurality of pairs of transparent electrodes are disposed on a front substrate and a discharge gap is formed between each pair of the transparent electrodes, the method comprising:
forming the transparent electrodes in a manner that an ink containing particles of metal or particles of metal oxide is applied, by inkjet printing, to the front substrate as a plurality of ink dots with different diameters.

2. The method for manufacturing a plasma display panel of claim 1, wherein a diameter of an ink dot on a side of the discharge gap of the transparent electrodes is printed smaller than diameters of other ink dots.

3. The method for manufacturing a plasma display panel of claim 2, wherein the transparent electrodes are formed of ink dots printed in two rows.
